(19) United States
(12) Patent Application Publication
(10) Pub. No.: US 2007/0024734 A1
(43) Pub. Date: Feb. 1, 2007

(54) Two-part camera system

(76) Inventor: Thomas D. Headley, Scottsdale, AZ (US)

Correspondence Address: BROMBERG & SUNSTEIN LLP, 125 SUMMER STREET, BOSTON, MA, 02110-1618, US

(21) Appl. No.: 11/496,276

(22) Filed: Jul. 31, 2006

Related U.S. Application Data
(60) Provisional application No. 60/704,589, filed on Aug. 1, 2005.

(51) Int. Cl. H04N 5/222

(52) U.S. Cl. 348/333.07

(57) ABSTRACT

A camera system is provided to record experiences, as moving or still images, directly into devices that may have various and sundry other functions. The camera system is intended to allow users to instantly view and share recorded images with others without any processing requirements. Users may view and share a recorded image anywhere and without any additional devices such as televisions or computers, and users may personalize items such as key chains, charms and other gift items. The camera system has two components: an imaging unit for capturing images and a viewing device. The imaging unit contains an imager that converts light into electrical signals, and an electrical connector. The viewing device, removable from the imaging unit, contains: an electrical connector that couples to the electrical connector on the imaging unit and carries electrical signals from the imaging unit, a memory that stores an image from the imaging unit, a display for viewing an image stored in the memory, and a processing unit that controls the imager and the viewing device. The viewing device does not contain an imager for capturing images, while the imaging unit does not include one or more or all of a memory for storing image information, a display for viewing an image, a processing unit for controlling the imager and the viewing device, or a power supply.

### CROSS REFERENCE TO RELATED APPLICATIONS

This application claims priority to provisional application Ser. No. 60/704,589, filed Aug. 1, 2005 by Thomas Douglas Headley, entitled “Instant Video Camera System with Self-Contained Video Viewing Device,” which is hereby incorporated by reference in its entirety.

### TECHNICAL FIELD AND BACKGROUND ART

The present invention relates to camera systems for capturing images and sounds, and more particularly, to camera systems where the image-display device controls the image-capture device and detaches from the image-capture device.

If one wants to record a special event with digital photography and load that recorded event into a display device, one must undertake several steps. First, one records the event or memory using a digital camera, then downloads the images into a computer or travels to a store to have them download the images, then processes and edits the images and finally uploads the images into the desired device. This process is too complicated and/or time consuming for many people to do. The disclosed camera system solves this problem by enabling a user to record an experience directly into the final display device without any additional steps or processes.

### SUMMARY OF THE INVENTION

The disclosed digital camera system is designed to record experiences directly into self-contained viewing devices that may have various and sundry other functions. The camera system is intended to allow users to instantly view and share recorded images with others without any processing requirements. Users may view and share a recorded image anywhere and without any additional devices such as televisions or computers, and users may personalize items such as key chains, charms and other gift items. In some preferred embodiments, the recorded image is a moving image.

In a first embodiment of the invention there is provided a camera system, having two components: an imaging unit for capturing images and a viewing device. The imaging unit contains an imager that converts light into electrical signals, and an electrical connector. The viewing device, removable from the imaging unit, contains: an electrical connector that couples to the electrical connector on the imaging unit and carries electrical signals to and from the imaging unit, a memory that stores an image from the imaging unit, a display for viewing an image stored in the memory, and a processing unit that controls the imager and the viewing device. The memory may be non-volatile solid state memory devices, including flash memory, serial flash memory and the like, as well as other removable media. In an alternative embodiment, the image may be stored on a microdrive or the like.

In preferred embodiments, the viewing device does not contain an imager for capturing images, while the imaging unit does not include one or more or, preferably, all of a memory for storing image information, a display for viewing an image, a processing unit for controlling the imager and the viewing device, or a power supply. In preferred embodiments, the imaging unit and the viewing device must be attached to each other in order to capture an image. The viewing device, on the other hand, can display an image while attached to the imaging unit and can display an image while detached from the imaging unit.

In another embodiment, the viewing device contains a power source for powering the entire system. In yet another embodiment, the viewing device contains a power connector suitable to power the system by attaching the connector to external power means. In still another embodiment, the imaging unit has a power button for turning the system power on and off.

In one embodiment, the imaging unit has a record button that causes the memory to store a single image. In alternative embodiments, pressing the imaging unit record button causes the memory to store either a sequence of still images or a moving picture. In another embodiment, momentarily pressing the imaging unit record button causes the memory to store a single image, while a sustained press of the record button causes the memory to store a sequence of still images. In an alternate embodiment, a sustained press of the record button causes the memory to store moving images. Alternatively, a rocker-type record button or other control mechanisms may be used for choosing the mode of recording, namely a still image, a sequence of still images or a moving image.

In another embodiment, the imaging unit contains both a record button and a two-position selector switch. In this embodiment a press of the record button causes the memory to store either a single image or a sequence of still images, according to the position of the selector switch. In an alternative embodiment, a press of the record button causes the memory to store either a single image or moving images, according to the position of the selector switch.

In still another embodiment, the viewing device also contains a play button for causing the viewer to display an image stored in the memory. In alternative embodiments pressing the play button causes the viewer to display a slideshow of still images, or moving images.

In an additional embodiment, the imaging unit has a microphone, and the viewing device has a speaker. The viewing device may also have a volume button for changing the loudness of the speaker. If the volume button is repeatedly pressed, the loudness of the speaker changes from a first loudness to a second loudness to a third loudness to silent, then to the first loudness again. Alternatively, a push-and-hold-type button may be used to control volume. Alternative volume controls include dials, thumb wheels, slew-type controls, and touchpads. Touchpads and joysticks can be used in alternative embodiments to control several functions including volume.

In embodiments with a microphone, the imaging unit may have a record button for causing the memory to store both an image captured by the imager, and a sound captured by the microphone. In alternative embodiments, the record button may capture a sound along with a sequence of still images, or moving images. In other alternative embodiments, the record button may store a sound together with a single image if it is momentarily pressed, or a sound together with still images or moving images if the button is held. If the image is a still image, the sound captured should last at least for some period of time sufficient to provide an intelligible message.

In other embodiments with a microphone, the imaging unit may have both a record button, and a two-position selector switch. In these embodiments, a press of the record button causes the memory to store a sound and either a single image or a sequence of still images, according to the position of the selector switch. In an alternate embodiment, a press of the record button may store either a still image or moving images, according to the position of the selector switch.

In another embodiment with a microphone, the viewing device has a play button for causing the viewer to display a single image stored in the memory and the speaker to emit a sound stored in the memory. In other microphone embodiments, pressing the play button causes the viewer to display a sequence of still images or moving images while playing a sound.

An alternative embodiment of the invention is directed to a separate viewing device, capable of being attached to and removed from an imaging unit that includes an imager that coverts light into electrical signals and an electrical connector electrically coupled to the imager. In this embodiment, the viewing device contains an electrical connector for carrying electrical signals to and from the imaging unit, a memory that stores an image based on electrical signals from the imaging unit, a display for viewing an image stored in the memory, and a processing unit that controls the imager and the viewing device.

Embodiments of the invention also include a method to store an image for later viewing, using the steps of providing an imaging unit, wherein the imaging unit includes an imager that coverts light into electrical signals, an electrical connector electrically coupled to the imager; connecting the imaging unit to a viewing device; converting light into electrical signals in the imaging unit; communicating the electrical signals to the viewing device; and storing the electrical signals in the viewing device. In one embodiment, the method may also include the steps of pressing a power button on the imaging unit after connecting the imaging unit to the viewing device, pressing a record button on the imaging unit after connecting the imaging unit to the viewing device, or both. In a preferred embodiment, a method to view stored images on a viewing device includes the steps described above to store an image, followed by the additional step of pressing a play button on the viewing device after optionally detaching the imaging unit from the viewing device. In preferred embodiments of the method, the viewing device—after it is removed from the imaging unit—is used for non-camera functions (such as a refrigerator magnet, a key fob, etc.)

### BRIEF DESCRIPTION OF THE DRAWINGS

The foregoing features of the invention will be more readily understood by reference to the following detailed description, taken with reference to the accompanying drawings, in which:

FIG. 1 is a front perspective view of one embodiment of the camera system, showing primarily the imaging unit.

FIG. 2 is a rear perspective view of the embodiment of the camera system from FIG. 1, wherein both the imaging unit and the viewing device are visible.

FIG. 3 is a front perspective view of another embodiment of the camera system, showing primarily the imaging unit.

FIG. 4 is a rear perspective view of the embodiment of the camera system from FIG. 3, wherein both the imaging unit and the viewing device are visible.

FIG. 5 is a rear perspective view of yet another embodiment of the camera system, wherein the viewing device is in the shape of a heart.

FIG. 6 is a schematic of one embodiment's imaging unit electrical system.

FIG. 7 is a schematic of one embodiment's viewing device electrical system.

FIG. 8 is a block diagram representing a method of using an embodiment.

FIG. 9A is a rear perspective view of an embodiment where the viewing device may serve the non-camera function of a refrigerator magnet.

FIG. 9B is a front perspective view of the embodiment of FIG. 9A.

FIG. 10A is a rear perspective view of an embodiment where the viewing device may serve the non-camera function of a key fob.

FIG. 10B is a front perspective view of the embodiment of FIG. 10A.

FIG. 10C is a rear perspective view of the viewing device of FIG. 10A after the imaging unit has been detached.

FIG. 11 shows a viewing device, according to an embodiment of the invention, incorporated into a photo album.

The terms “front” and “rear,” as used herein to describe various views, are based on the item's use as a camera, when the imaging unit is connected to the viewing device. When the viewing device is used for a non-camera function, what was the rear of the camera may become the front of the item (e.g., the front of a refrigerator magnet).

### DETAILED DESCRIPTION OF SPECIFIC EMBODIMENTS

Definitions. As used in this description and the accompanying claims, the following terms shall have the meanings indicated, unless the context otherwise requires:

“Still image” means a visual reproduction, for a viewer, on a display, of a single non-moving image.

“Moving image” means a visual reproduction, for a viewer, on a display, of several images, in sequence, at such a rate that the viewer experience a ‘persistence of vision’ effect. Typically, at least about six—and preferably at least about twelve—images per second need to be shown for a sequence of images to appear as a moving image.

“Memory” includes all types of compact, non-volatile storage, including mechanisms such as flash memory and microdrives.

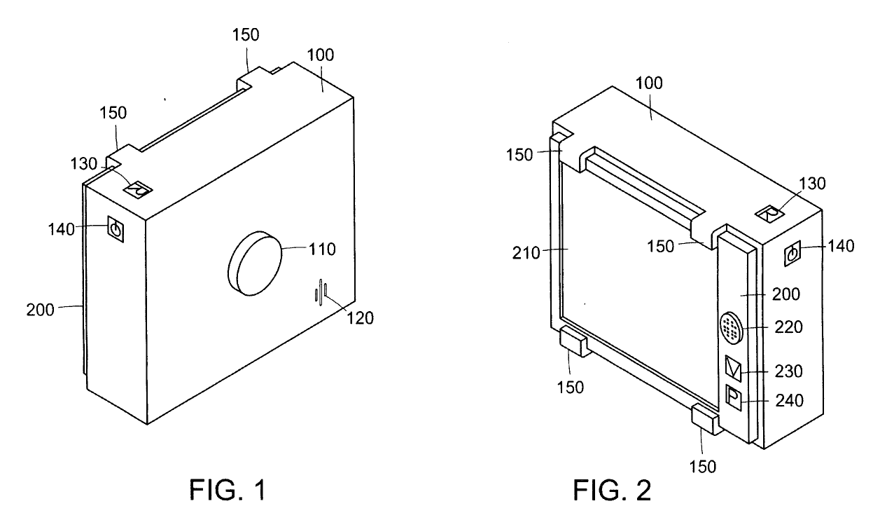

One embodiment of the camera system is depicted in FIG. 1 and FIG. 2. The system depicted is dimensioned so as to fit comfortably in a person's hand, facilitating ease of use. In FIG. 1 the imaging unit 100 is primarily visible, while only a portion of the viewing device 200 is visible. Several features of the imaging unit are shown: the imager 110, a microphone 120, a record button 130, an on/off button 140, and a mechanical connector 150. The electrical connector is not depicted here. In FIG. 2 the viewing device is primarily visible. Several features of the viewing device are shown: the display 210, a speaker 220, a volume button 230, and a play button 240.

When using the camera system in an embodiment, a user begins by sliding the imaging unit 100 and viewing device 200 together until the electrical connectors are fully mated. Alternatively, the imaging unit and the viewing device are sold to the user already assembled.

The user pushes the on/off button 140 to power up the camera system. Light entering a lens in the imager 110 is directed to a CMOS sensor (not depicted) and converted to digital signals. The digital signals are sent to a processing unit in the viewing device 200 and displayed on the display 210. The user then points the camera system at a desired target using an image on the viewing device's display to aim and pushes a record button 130 when he is ready to begin recording. When the user is recording, the digital signal sent from the imager 110 to the viewing device 200 continues to be displayed on the display 210 but is also sent to a memory in the viewing device 200.

At the same time, a microphone 120 detects sounds and converts them into electrical audio signals. The processing unit may digitize the electrical audio signal, and the digitized audio signals are also recorded into the viewing device 200. Compression technology may or may not be used to reduce memory requirements. When the memory is full, the system stops and displays on the display 210 the last picture recorded.

A user may review the recorded video by pushing the play button 240 on the viewing device 200. The camera system will replay the video on the viewing device's display 210 and play the recorded audio using the speaker 220. If the user is not satisfied with his recorded experience, he may repeat the process above and record over the existing data in memory until he is satisfied. In one embodiment, a control is provided to permit the user to record the audio separately from the images, so that on play-back the audio can be of a voice-over quality.

When the user is satisfied, he slides the imaging unit 100 and viewing device 200 apart. The user or someone else can then begin to use the viewing device 200 for an alternate use (for example, as a keychain fob) but the viewing device 200 is also immediately able to replay the video on the display 210 with the speaker 220, and can replay it as often as desired. The imaging unit 100 is available to be used with another viewing device.

The imager 110 depicted in FIG. 1 uses a lens. In one embodiment, this lens has behind it a complementary-symmetry/metal-oxide semiconductor (CMOS) sensor (not depicted). If a CMOS sensor is employed, the lens focuses light onto the sensor, which converts that light into electrical signals, in accordance with the invention. Other imagers which are able to convert light into electrical signals are contemplated. For example, a charge-coupled device (CCD) may be employed instead of a CMOS sensor.

A microphone 120 is also shown in FIG. 1. Microphone technology is well-known in the art of camera systems, and one can obtain microphones in a large variety of shapes and sizes. Any microphone suitable to the dimensions and applications of an embodiment of the invention is contemplated.

A display 210 is shown in FIG. 2. The display must be suitable for the size and shape of the viewing device 200. As viewing devices can have many different purposes besides being part of a camera system, many different displays may be used. Different display technologies include without limitation liquid crystal displays (LCDs), light-emitting diode (LED) displays, organic LED displays and electronic paper.

FIG. 2 also depicts a speaker 220. Speaker technology is well-known in the art of camera systems, and one can obtain speakers in a large variety of shapes and sizes. Any speaker suitable to the dimensions and applications of an embodiment of the invention is contemplated.

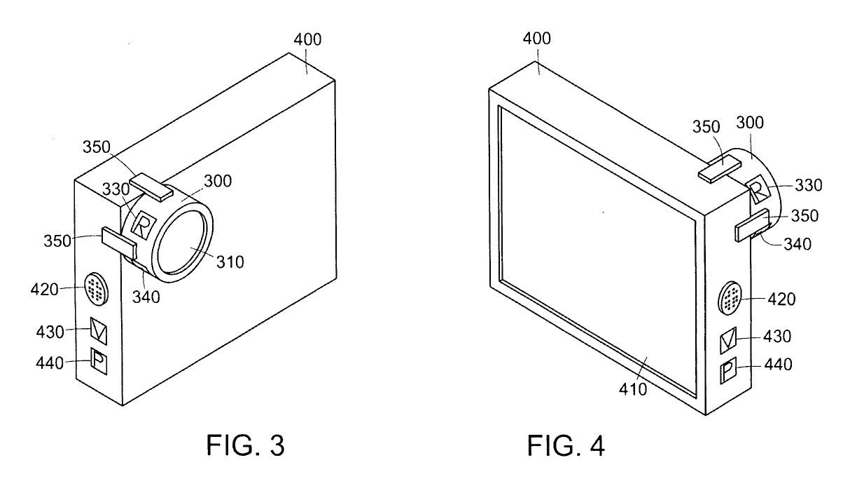

FIG. 3 and FIG. 4 show front and rear views of another embodiment of the invention. Here, the imaging unit 300 is smaller than in FIG. 1, while the viewing device 400 is larger than its counterpart. These figures again show several aspects of the invention. The imager 310 is present, along with the record button 330 and the power button 340. Instead of latching straps, this embodiment uses frangible supports 350. FIG. 4 shows the rear of the viewing device 400, including the display 410, a speaker 420, a volume button 430, and a play button 440.

In the two embodiments shown in FIGS. 1-4, the main function of the imaging unit is to capture still images, moving images and/or sound. An imaging unit may be used many times with viewing devices of different sizes and shapes. The imaging unit preferably includes a lens and a component for converting light into electrical signals, and the imaging unit preferably lacks one or more or, preferably, all of: a memory for storing image information, a display for viewing an image, a processing unit for controlling the imager and the viewing device, or a power supply. The main functions of the viewing device are to record and display the captured images and sounds. In preferred embodiments, the viewing device has a system processing unit, memory, software, a power system (i.e. battery), a speaker and a display device, and the viewing device preferably lacks a lens and a component for converting light into electrical signals. The viewing device can replay recorded images many times after being disconnected from an imaging unit. Mated together, the imaging unit and the viewing device form a complete, functioning camera system. After a desired image has been recorded, the viewing device will operate independently from the imaging unit to replay what has been recorded.

A preferred use of the camera system is to record and replay moving picture videos; however, the system can also be used to record single still photographs. In alternative embodiments, it can be used to record multiple still photographs which can be replayed as a slide show. In other embodiments, the camera system can be used to mix moving and still images in any combination the user desires. Another function of the camera system in a preferred embodiment is to add audio to recorded visual images, whether the images are moving or still images. In one embodiment, the audio is always on during the recording of a video and on for a predetermined time (i.e. 5 seconds or 10 seconds) for each still photograph. Alternately, the audio portion can be disabled if the user desires.

The buttons and switches required to control the camera system can be located in various places. In one embodiment, the imaging unit has two buttons, an on/off button and a record button, and the viewing device has two buttons, a play button and a volume button. The location of the buttons in this embodiment is attractive because it minimizes the buttons on the viewing device; however, other button locations may also be used. Additional buttons could be added along with additional features in other embodiments. For example, a selector switch may be used to change the mode of image capture (e.g., either still or moving images).

When functioning as a digital camera system, the imaging unit and viewing device are connected together electronically and mechanically. Electronically they may couple using a multi-pin electrical connector, edge connector, or any other suitable electrical connector. Mechanically they are removably but stably attached so they do not come apart accidentally. In one embodiment, the imaging unit incorporates two short rails with a T-shaped cross-section and the viewing device incorporates two slots to accept the rails. To connect the imaging unit to the viewing device, a user inserts the imaging unit's rails into the viewing device's slots and slides the two units together until the electrical connectors are fully mated. The imaging unit and viewing device can be separated by simply pulling them apart. Any other method for mechanically connecting the two components is contemplated. Other mechanical means of attachment include without limitation, snapping together, strapping together (Velcro plus other types of straps), attaching with one or more screws, spring clips, friction fit, compression fit, hook, sliding pin, latching, and spring loaded balls or tongues.

In one embodiment, the volume button is active only when the display is replaying a recorded memory. Multiple pushes of the volume button cycles the speaker volume. The volume may cycle from high to medium to low to mute and back to high again, or from low to medium to high to mute and back to low again.

In another embodiment, the camera system determines whether the user wants to record a still photograph or a moving picture video by monitoring the record button. In this embodiment, if the user presses and releases the record button, the camera system records a still photograph. However, if the user presses and holds the record button, the camera system records a video as long as the record button is held down or until memory is full. In yet another embodiment, an additional switch or button is added the imaging unit allowing the user to select which mode of operation is of interest at that moment.

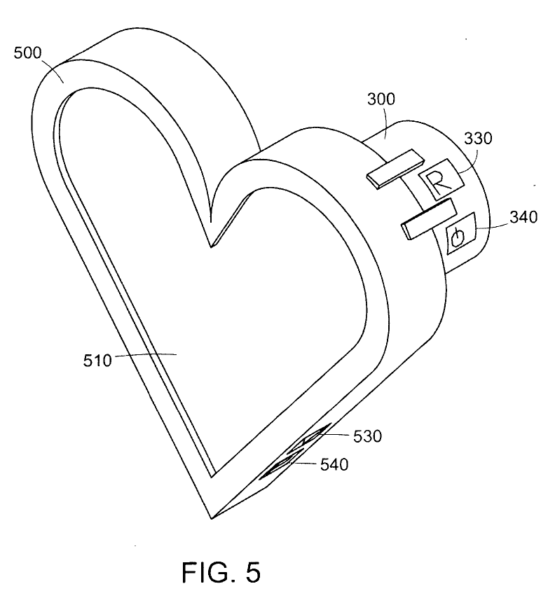

A novelty viewing device in the shape of a heart is shown in FIG. 5. Such a device could be used as a present, or as a keepsake of an important event such as a wedding. The figure shows a viewing device 500, its display 510, a volume button 530, and a play button 540. This viewing device 500 uses the same imaging unit 300 shown in FIGS. 3 and 4.

The invention contemplates viewing devices of many shapes and sizes. The housing of the viewing device may be made of metal, plastic, wood or even cardboard. The housing of the viewing device may have a decorative frame surrounding the display, or the housing may be adapted to receive a decorative frame after the viewing device is detached from the imaging unit.

The viewing device may be designed to serve other, non-camera purposes after a user stores an experience on a viewing device and detaches the device from the imaging unit. For example, a viewing device detached from the imaging unit may also function as, without limitation: a refrigerator magnet, a locket, a wall clock, a desk clock, an alarm clock, a wrist watch, a photo album cover, a greeting card, a trophy, an award plaque, a memento, a purse, a lady's compact, a key fob, a paperweight, a pen and pencil set, a calculator, a letter opener, a coffee cup, a pendant, a brooch, a pocket knife, a money clip, an object with a hole to look into, an instructional device, a holiday ornament, a thermometer, a barometer, a diary, a picture frame, a wallet, a credit card, a desk ornament, a souvenir, a mouse pad, a figurine, a replica of a larger object, a golf ball marker, a tool, a bag name tag, a name tag, an identity tag, a napkin holder, a place marker, a bookmark, an article of clothing, a notebook, a hair brush, a mirror, a notepaper holder, a bottle opener, a corkscrew, a pet's collar, a pet's identification tag, electronic paper, a postcard or similar item for mailing, and a business card. Any item of personal property which one might want to personalize with images or sound is contemplated. All of these items may be connected to an imaging unit and thereby become part of a digital camera system. After an experience has been recorded, a viewing device can be disconnected from an imaging unit and can replay the recorded experience on demand without further processing or other supporting systems.

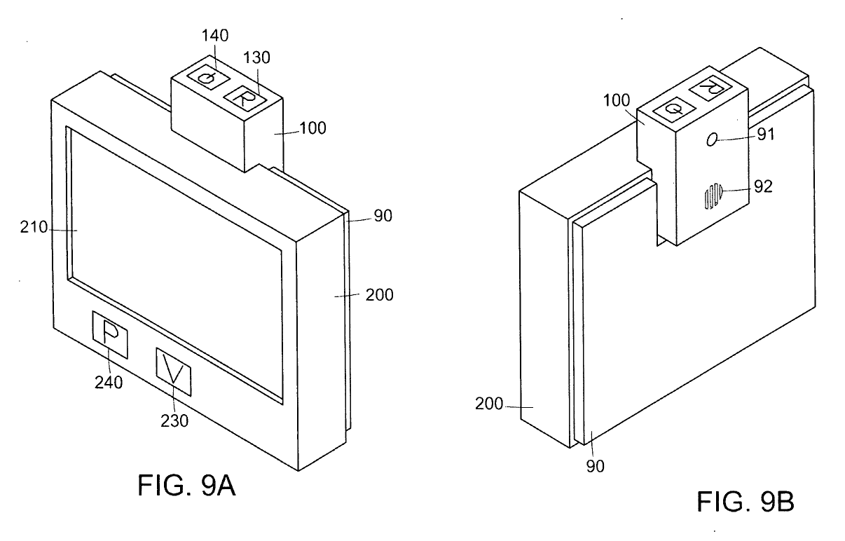

For some items, such as a locket, a name tag or a key fob, it may be practicable to attach the entire item to the imaging unit, so that when the item is removed from the imaging unit it can immediately begin to function as a locket, a name tag, a key fob, or other item. Alternatively, the viewing device may be inserted into or attached to another item after it has been detached from the imaging unit. For example, after the desired images are recorded onto the viewing device, the viewing device is detached from the imaging unit and inserted into or attached to a wall clock, a large trophy, a photo album or other large item. Examples of how the viewing device may be used are discussed below in connection with FIGS. 9A-11.

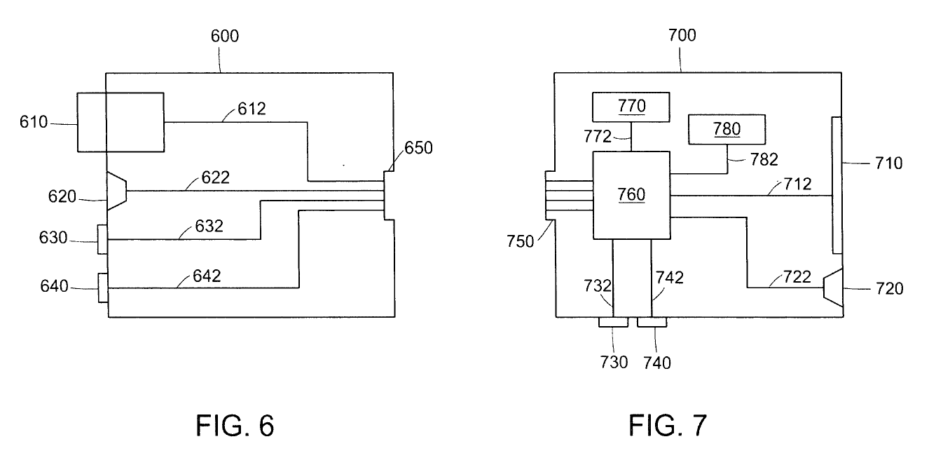

FIG. 6 is an electrical schematic of one embodiment of an imaging unit. The imaging unit 600 contains an imager 610, a microphone 620, a record button 630, and an on/off button 640. These components are connected to an electrical connector 650 by an electrical system. In this depiction, an electrical conduit 612 (e.g., a trace or set of traces on a printed circuit board, or a wire or set of wires) connects the imager 610 to the electrical connector 650, and other electrical conduits 622, 632 and 642 connect the microphone, record button, and on/off button respectively. Alternatively, a selector switch or other control mechanism may be used to change the mode of operation.

FIG. 7 shows a corresponding viewing device. The viewing device 700 contains a display 710, a speaker 720, a volume button 730, and a play button 740. In addition to these features, the viewing device 700 also contains an electrical connector 750, a processing unit 760, a memory 770, and a power source 780. The viewing device 700 may have any shape required by a particular use, as noted above. The processing unit 760 controls the functions of all components in the camera system. In this embodiment, the processing unit connects to all components in the viewing device 700 directly, and to the components in the imaging unit 600 through the electrical connector 750. Several electrical conduits 712, 722, 732, 772 and 782 connect the processing unit 760 to the display 710, the speaker 720, the volume button 730, and the play button 740 the memory 770, and the power source 780, respectively.

The electrical connector 750 has the proper dimensions to couple electrically and mechanically with the electrical connector 650. When such a coupling occurs, the electrical conduits 612, 622, 632, and 642 connect to the processing unit 760. In this way, the processing unit 760 controls the operation of all functional components of the camera system. Other forms of electrical connection that are sufficient to connect the functional components of an imaging unit to a viewing device processing unit are intended. Such forms include multi-pin connectors, and edge connectors.

Viewing device 700 also contains a memory 770. Memory technology is well-known in the art of camera systems, and one can obtain memory in a large variety of shapes, sizes, and capacities. Any memory suitable to the dimensions and applications of an embodiment of the invention is contemplated. Preferably, the memory is a non-volatile solid state memory device, such as flash memory, serial flash memory and the like.

Viewing device 700 also contains a power system 780. The power system provides power to all of the components in the camera system (additional power connections not depicted). When the on/off button 640 is pressed, the processing unit 760 directs power from the power unit 780 to all of the components in the camera system. Any type of power system that is properly dimensioned and can provide sufficient electrical power may be used. For example, the power system 780 may be a battery or collection of batteries. It might also be a solar cell. In addition to supplying internal power, the power system 780 may have an external electrical connector (not depicted), which obtains its power from an external source. Such an external source may be a power cord connected to an electrical outlet or an external battery pack (not depicted).

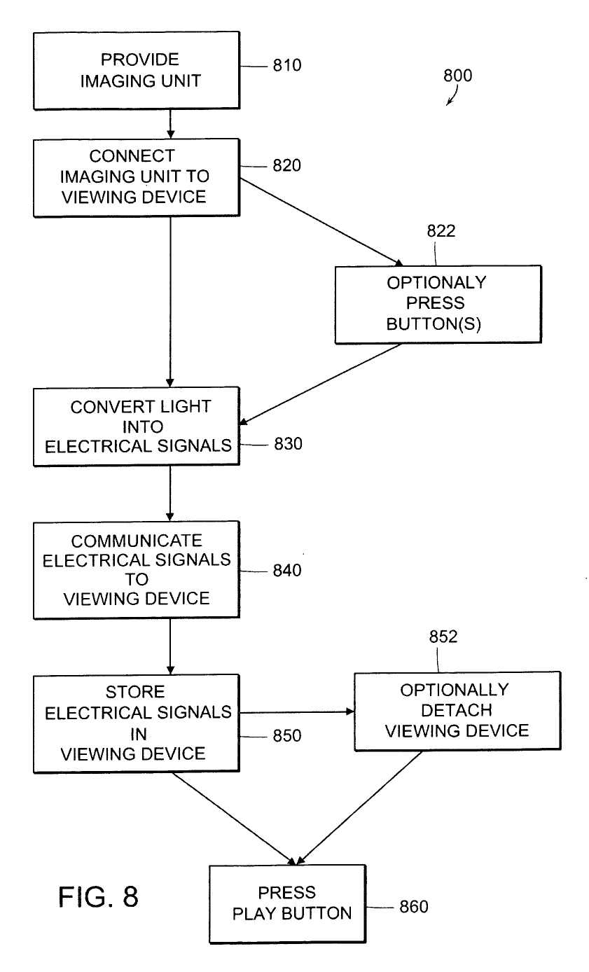

FIG. 8 depicts a method 800 of using an embodiment of the invention. A user would first have a viewing device, such as a key fob, refrigerator magnet, or locket. The viewing device must have an electrical connector, a power system, and a way to store electronic signals and display them as images. To begin the process, a user would first provide an imaging unit in step 810. The imaging unit must be able to capture images. The imaging unit must also be able to communicate these images to the viewing device through an electrical connector. Once both the imaging unit and viewing device are in hand, the user next connects the imaging unit to the viewing device, as in step 820. (Alternatively, this step 820 may be performed at an assembly plant prior to the sale to the user.) The devices, once joined, should be mechanically stable, and their components electrically connected.

In one embodiment, power is transferred from the viewing device to the imaging unit as soon as the two are connected. In another embodiment, power is only supplied to the imaging unit after a power button is pressed, as in step 822. In one embodiment, the imager converts light into electrical signals in step 830 as soon as power is applied. Optionally, the imager does not convert light into electrical signals in step 830 until the user presses a record button in step 822. In an embodiment where a user must press both a power button and a record button, step 822 includes pressing the power button first, then pressing the record button.

Once the imager converts light into electrical signals, those signals are sent to the viewing device in step 840. This occurs without any user intervention, as the imager is connected to the viewing device by an electrical connection. The viewing device then stores the electrical signals in step 850 for later viewing. While the viewing device is attached to the imaging unit, the viewing device can display the image being captured by the imaging unit and thus can act as a viewfinder.

FIG. 8 also shows how a user views images that have been previously stored using the above method. Once the images have been stored, a user may press a play button on the viewing device, as in step 860. The user may leave the viewing device mechanically and electrically connected to the imaging unit while viewing the stored images. This capability allows a user to record several images in sequence, or to record an image several times if the first stored image is unsatisfactory. The viewing device may also be provided with a rewind button or the like. By using a rewind button or the like, the user can over-write a previously recorded image or images, or start a new moving image in the middle of a prior moving image (thereby deleting the end of the prior moving image), or completely record over (and delete) a prior moving image. The same function may be accomplished without a rewind button, by using the play button to advance to the position where the new image or images are to begin. (The play button is preferably programmed to cause the images to start over again from the beginning after the play button is pressed again after all the images are displayed.)

When the user is satisfied with the image or images collected on the viewing device, the user may wish at that point to detach the viewing device, as shown in step 852. Once the user has captured an acceptable image, the user may wish to detach the viewing device to use it for an alternative, non-camera purpose.

FIGS. 9A and 9B show an embodiment where the viewing device may serve the non-camera function of a refrigerator magnet. This embodiment has much in common with the embodiments shown in FIGS. 1-4, but it further includes a magnet 90. This embodiment includes an imaging unit 100 and a viewing device 200. The viewing device includes the magnet 90, so that the viewing device can be used as a refrigerator magnet after the imaging unit is detached. Like in the above-described embodiments, the imaging unit is detachable from the viewing device.

While the imaging unit and viewing device are connected to each other, they function as a camera, and images are recorded and stored in the viewing device's memory. After the desired images are stored in memory, the imaging unit and viewing device are disconnected from each other, and then the viewing device may be used as a refrigerator magnet having a display 210 for showing the stored images. The imaging unit includes a lens opening 91, a microphone opening 92, a record button 130, and an on/off button 140. The viewing device includes a volume button 230 and a play button 240, as well as the magnet 90 and the display 210.

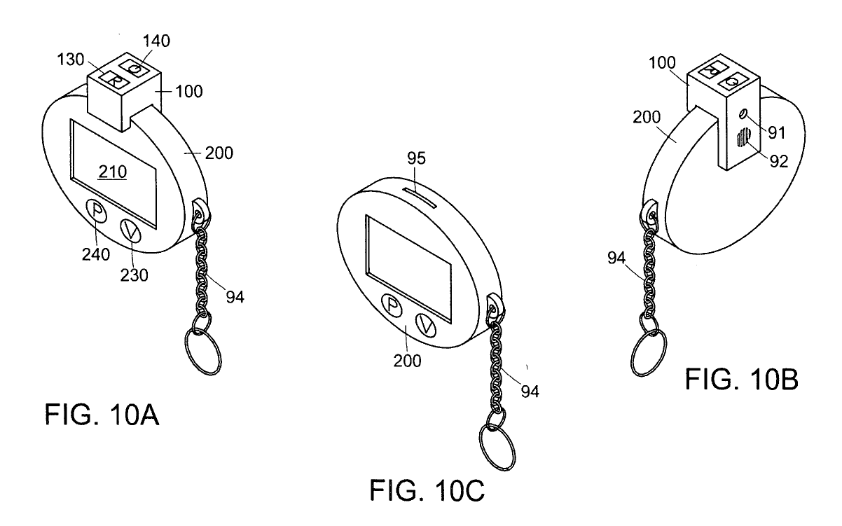

FIGS. 10A and 10B show an embodiment that is similar to the one shown in FIGS. 9A and 9B, except the viewing device 200 in FIGS. 10A and 10B is intended to be used as a key fob. Thus, the viewing device in FIGS. 10A and 10B includes a chain 94, and the housing of the viewing device is oval instead of rectangular. The imaging unit 100 includes a lens opening 91, a microphone opening 92, a record button 130, and an on/off button 140. The viewing device 200 includes a volume button 230, a play button 240, a display 210, as well as the chain 94. As in the above-described embodiments, the imaging unit 100 and the viewing device 200 function as a camera while they are connected. After the images are stored in memory, the imaging unit is removed, leaving only the viewing device with its chain 94 to function as a key fob, as shown in FIG. 10C. An electrical connector slot 95, through which electrical communication passes between the viewing device and the imaging unit when they are attached to each other, is visible in FIG. 10C.

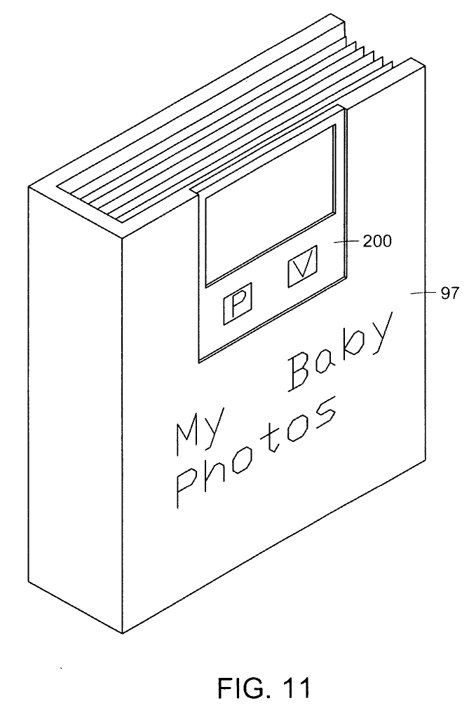

FIG. 11 shows a viewing device 200, according to an embodiment of the invention, incorporated into a photo album 97. In one embodiment, the viewing device is separable from the photo album. To record images on the viewing device, it is attached to an imaging unit and used as described above. After the desired images are recorded into the memory of the viewing device, the viewing device is separated from the imaging unit and inserted into a receiving slot on the front cover of the photo album to obtain the photo album shown in FIG. 11.

Although various exemplary embodiments of the invention have been disclosed, it should be apparent to those skilled in the art that various changes and modifications can be made which will achieve some of the advantages of the invention without departing from the true scope of the invention. These and other obvious modifications are intended to be covered by the appended claims.

What is claimed is:

1. A camera system, comprising:
an imaging unit for capturing images, the imaging unit comprising:
an imager that converts light into electrical signals, and
an imaging unit electrical connector electrically coupled to the imager; and
a viewing device, removable from the imaging unit, the viewing device comprising:
a viewing device electrical connector, being suitable for coupling with the imaging unit electrical connector and carrying electrical signals from the imaging unit,
a memory that stores an image based on electrical signals from the imaging unit,
a display for viewing an image stored in the memory, and
a processing unit that controls the imager and the viewing device.

2. The system of claim 1, wherein the viewing device further comprises:
a power source for powering the system.

3. The system of claim 1, wherein the viewing device further comprises:
a power connector suitable to power the system, by attaching the connector to external power means.

4. The system of claim 1, wherein the imaging unit further comprises:
a power button for turning the system power on and off.

5. The system of claim 1, wherein the imaging unit further comprises:
a record button for causing the memory to store one or more still images captured by the imager.

6. The system of claim 1, wherein the imaging unit further comprises:
a record button for causing the memory to store a moving image captured by the imager.

7. The system of claim 1, wherein the imaging unit further comprises:
a record button, such that pushing the record button for different time periods will cause the memory to store a single image, a sequence of images or moving images captured by the imager.

8. The system of claim 1, wherein the viewing device further comprises:
a play button for causing the viewer to display an image stored in the memory.

9. The system of claim 1, wherein the imaging unit further comprises:
a microphone.

10. The system of claim 9, wherein the viewing device further comprises:
a speaker having a loudness.

11. The system of claim 10, wherein the imaging unit further comprises:
a record button for causing the memory to store:
an image captured by the imager, and
a sound captured by the microphone.

12. The system of claim 10, wherein the viewing device further comprises:
a play button for causing the viewer to display one or more still images stored in the memory and the speaker to emit a sound stored in the memory.

13. The system of claim 10, wherein the viewing device further comprises:
a play button for causing the viewer to display a moving image stored in the memory and the speaker to emit a sound stored in the memory.

14. The system according to claim 1, wherein the imaging unit does not include memory for storing image information.

15. The system according to claim 1, wherein the imaging unit does not include a display for viewing an image.

16. The system according to claim 1, wherein the imaging unit does not include a processing unit for controlling the imager and the viewing device.

17. The system according to claim 1, wherein the imaging unit does not include a power supply.

18. The system according to claim 1, wherein the viewing device does not contain an imager for capturing images.

19. The system according to claim 1, wherein the imaging unit and the viewing device must be attached to each other in order to capture an image, and wherein the viewing device can display an image while attached to the imaging unit and can display an image while detached from the imaging unit.

20. A camera system, comprising:
an imaging unit for capturing images, the imaging unit comprising:
means for converting light into electrical signals, and
means for communicating the electrical signals to another device; and
a viewing device, removable from the imaging unit, the viewing device comprising:
means for receiving electrical signals from the imaging unit,
means for storing the electrical signals received by the receiving means,
means for viewing as an image the electrical signals stored by the storing means, and
means for controlling the light converting means and the viewing device.

21. The system of claim 20, wherein the imaging unit further comprises:
means for converting sound into electrical signals.

22. The system of claim 21, wherein the viewing device further comprises:
means for converting into sound electrical signals stored by the storing means.

23. A viewing device capable of being attached to and removed from an imaging unit, the imaging unit including an imager that coverts light into electrical signals and an electrical connector electrically coupled to the imager, the viewing device comprising:
a viewing device electrical connector, being suitable for coupling with the imaging unit electrical connector and carrying electrical signals from the imaging unit,
a memory that stores an image based on electrical signals from the imaging unit,
a display for viewing an image stored in the memory, and
a processing unit that controls the imager and the viewing device.

24. The viewing device according to claim 23, wherein the viewing device has one or more non-camera functions when not attached to the imaging device.

25. The viewing device according to claim 23, wherein the viewing device is adapted to be attached to a non-camera item when not attached to the imaging device.

26. A method to store an image for later viewing, comprising the steps of:
providing an imaging unit, wherein the imaging unit includes an imager that converts light into electrical signals, and an electrical connector electrically coupled to the imager,
electrically connecting the imaging unit to a viewing device, wherein the viewing device has an electrical connector suitable for coupling to the imaging unit, and means for storing electrical signals,
converting light into electrical signals in the imaging unit,
communicating the electrical signals to the viewing device using the electrical connection,
storing the electrical signals in the viewing device
detaching the imaging unit from the viewing device, and
pressing a play button on the viewing device.

27. The method of claim 26, comprising the additional step of:
pressing a power button on the imaging unit after connecting the imaging unit to the viewing device.

28. The method of claim 26, comprising the additional step of:
pressing a record button on the imaging unit after connecting the imaging unit to the viewing device.

29. The method of claim 26, comprising the additional step of using the viewing device in a non-camera function after being detached from the imaging device.

30. A method to store an image for later viewing, comprising the steps of:
providing an imager that converts light into electrical signals;
providing memory in a device for storing an image based on the electrical signals from the imager, wherein the device has a non-camera function selected from the group consisting of:
a refrigerator magnet, a locket, a photo album cover, a trophy, an award plaque, a memento, a purse, a lady's compact, a key fob, a paperweight, a pen and pencil set, a letter opener, a coffee cup, a pendant, a brooch, a pocket knife, a money clip, a holiday ornament, a thermometer, a barometer, a diary, a picture frame, a wallet, a desk ornament, a souvenir, a mouse pad, a figurine, a golf ball marker, a tool, a bag name tag, a name tag, an identity tag, a napkin holder, a place marker, a bookmark, an article of clothing, a notebook, a hair brush, a mirror, a notepaper holder, a bottle opener, a corkscrew, a pet's collar, and a pet's identification tag;
providing a display in a device for showing the image stored in the memory;
recording an image so as to store it in memory;
using the device for a non-camera function; and
activating the device so as to cause the image stored in memory to be shown on the display.

31. A method according to claim 30, wherein the device is selected from the group consisting of a refrigerator magnet, a key fob, a trophy, a pen-and-pencil set, a money clip, a holiday ornament, a desk ornament, an identity tag and a pet's identification tag.

32. A method according to claim 30, wherein the device is selected from the group consisting of a refrigerator magnet, figurine, an identity tag, and a holiday ornament.

33. A method according to claim 30, wherein the device is selected from the group consisting of a refrigerator magnet and a holiday ornament.
